(19) United States
(12) Patent Application Publication
(10) Pub. No.: US 2011/0226564 A1
(43) Pub. Date: Sep. 22, 2011

(54) Device for Recognizing Wear of a Brake Pad of a Disc Brake, and Brake Pad for a Disc Brake

(75) Inventor: Borislav SALAPIC, Muenchen (DE)

(73) Assignee: KNORR-BREMSE Systeme fuer Nutzfahrzeuge GmbH, Muenchen (DE)

(21) Appl. No.: 12/951,614

(22) Filed: Nov. 22, 2010

Related U.S. Application Data
(63) Continuation of application No. PCT/EP2009/003887, filed on May 29, 2009.

(30) Foreign Application Priority Data
May 30, 2008 (DE) DE 102008026104.1

(51) Int. Cl. F16D 66/02

(52) U.S. Cl. 188/1.11 W

(57) ABSTRACT

A device for recognizing wear of a brake pad of a disc brake includes a holder that can be inserted in a pad carrier plate of the brake pad for holding a contact conductor. A contact arm of the holder has a receptacle for the contact conductor. A clamping element of the holder is connected to the contact arm and has two clamping arms elastically movable relative to one another. The device is designed such that transition regions between the clamping element and the contact arm are rounded in the direction of the clamping arms.

### CROSS-REFERENCE TO RELATED APPLICATIONS

This application is a continuation of PCT International Application No. PCT/EP2009/003887, filed May 29, 2009, which claims priority under 35 U.S.C. §119 from German Patent Application No. DE 10 2008 026 104.1, filed May 30, 2008, the entire disclosures of which are herein expressly incorporated by reference.

### BACKGROUND AND SUMMARY OF THE INVENTION

The invention relates to a device for recognizing wear of a brake pad of a disc brake, and to a brake pad of a disc brake.

For monitoring the thickness of friction linings, in particular for determining an admissible wear limit of the friction lining of the brake pad, there are known contact conductors, for example in the form of cables. Upon attainment of the wear limit, that is, when the friction lining has been abraded to a corresponding extent, the contact conductors brush against the brake disc, which is in contact with the friction lining during braking, whereby an electrical pulse is sent to a signal transmitter. This signal transmitter indicates that the admissible wear limit of the brake pad has been reached and that replacement is necessary.

A contact conductor of this type is fixed in a generic device which, as a mounting, engages in a clamped manner in a pad carrier plate of the brake pad, which carries the friction lining. In this case, the contact arm through which, for example, the cable passes, is accommodated in a recess of the friction lining and projects into same to such an extent that the recessed cable is positioned at a predetermined minimum thickness of the friction lining.

To form the clamped connection of the mounting to the pad carrier plate, the clamping element is equipped with two clamping arms, which can be pressed elastically towards one another in order to insert the mounting in the pad carrier plate, and then are pressed against the wall of the recess of the pad carrier plate by the inherent restoring forces of the clamping arms. This produces a frictional engagement which secures the mounting in the direction of insertion.

On its side oriented towards the pad carrier plate, the contact arm is provided with contact faces which rest against the pad carrier plate, while the clamping arms also have angled contact faces which abut against the other side of the pad carrier plate, so that the mounting is fully secured against displacement in the recess.

Hitherto, the transition between the contact arm and the clamping element has been configured with a sharp corner, at least in the spreading direction, producing a notch effect, which has the result that these regions are prone to cracking, especially because of the high mechanical stress during driving operation of a commercial vehicle, in which, in particular, such brake pads are installed.

As a result of the cracks produced, the restoring forces necessary for clamping are not effective to the required degree, so that secure retention under all operating conditions is not ensured.

It is the object of the invention to develop a device and a brake pad such that the service life and operability thereof are improved.

This object is achieved by a device, and attendant brake pad, for recognizing wear of the brake pad of a disc brake, including a holder which can be inserted in a pad carrier plate of the brake pad for holding a contact conductor, and a contact arm having a receptacle for the contact conductor, to which contact arm is connected a clamping element with two clamping arms which can be moved elastically towards one another. The transition regions between the clamping element and the contact arm are rounded in the spreading direction of the clamping arms.

Such a device is characterized, above all, by its robustness, that is, by its lack of susceptibility to cracking even under the most severe operating conditions with regard to shocks occurring while driving. By its nature, this leads to an entirely remarkable cost saving, as compared to the state of the art, since procurement of a replacement part and the resulting installation outlay is no longer required, or must no longer be executed. In addition, the improvement of operating safety is a further criterion distinguishing the invention.

Whereas hitherto the device was able to slip out of its clamped position as a result of the lack of secure clamping through cracking, this is prevented by the invention, so that the device remains fully operative practically over the service life of the brake pad, which also enhances the safety of the entire system.

According to an advantageous embodiment of the invention, it is provided that the rounding in the respective transition region between the contact arm and the clamping element is produced by a groove-shaped recess, the lateral surface of which is arcuate in cross section. This is accompanied by a reduction in the cross section of the contact arm in this region, producing a certain resilience which also contributes to avoidance of cracking.

Other objects, advantages and novel features of the present invention will become apparent from the following detailed description of one or more preferred embodiments when considered in conjunction with the accompanying drawing.

### BRIEF DESCRIPTION OF THE DRAWINGS

FIG. 1 shows, in a top view, a part of a device for recognizing wear according to the state of the art;

FIG. 2 shows a brake pad according to an embodiment of the invention in a front view;

FIG. 3 shows an enlarged partial detail of the brake pad in a top view;

FIG. 4 shows a partial detail designed by IV of the brake pad in FIG. 2; and

FIG. 5 shows a detail of the device in a top view.

### DETAILED DESCRIPTION OF THE DRAWINGS

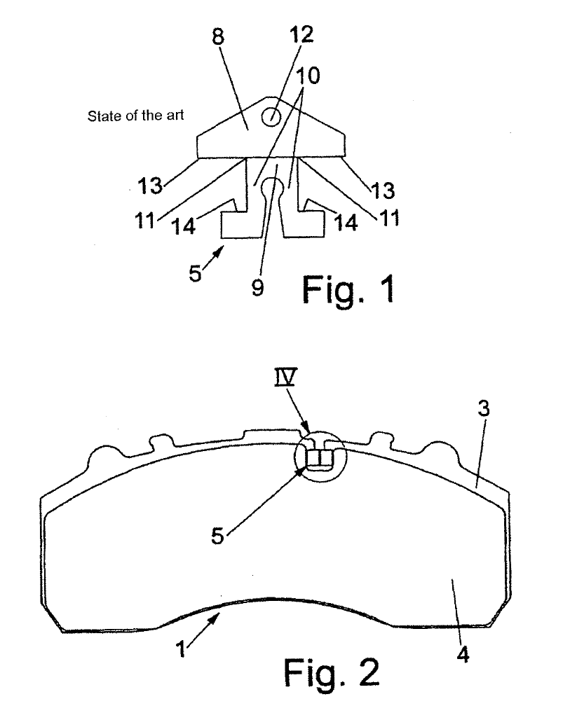

FIG. 1 shows a holder 5 according to the state of the art of a device for recognizing wear of a brake pad of a disc brake, which brake pad is shown in a front view in FIG. 2.

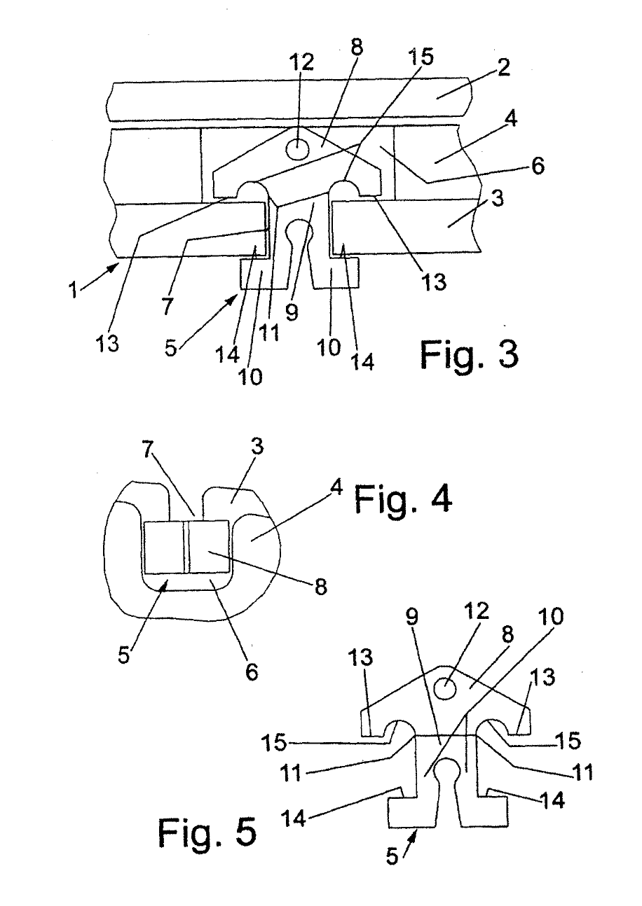

The brake pad 1 has a pad carrier plate 3 and a friction lining 4 which is fastened thereto and can be pressed against a brake disc 2 (FIG. 3) during braking.

The holder 5 of FIG. 1, like that according to an exemplary embodiment of the invention (FIGS. 3 and 5), has a contact arm 8 with contact faces 13 which rest against the pad carrier plate 3. In addition, an opening 12, through which a cable (not shown) serving as a wear sensor can pass, is provided in the contact arm 8.

The holder 5 is clamped in an opening 7 of the pad carrier plate 3, while the contact arm 8 projects into a recess 6 of the friction lining material 4.

In this case, the distance of the opening 12 and of the cable fitted therein from the pad carrier plate 3 corresponds to the minimum admissible thickness of the friction lining 4. If the friction lining material 4 is abraded by contact with the brake disc 2 to the extent that the brake disc 2 contacts the cable and the conductor located therein, this is recognized by a signal transmitter and is displayed.

Connected to the contact arm 8 is a clamping element 9 having two clamping arms 10 which are movable elastically towards one another and which bear with a frictional engagement against the wall of the opening 7 in the spread position.

On the side oriented away from the contact arm 8, the clamping arms 10 have angled contact faces 14, which bear against the side of the pad carrier plate 3 oriented away from the friction lining 4.

As can be clearly seen in FIG. 1, which reproduces the state of the art, the transition region, denoted by reference numeral 11, between the clamping element 9 and the contact arm 8 is configured with a sharp corner in each case.

According to an embodiment of the invention, this transition region 11 is rounded in the holder 5 (FIGS. 3 and 5), specifically, in the present exemplary embodiment, in the form of a groove 15 having an arcuate contour.

Each contact face 13 then adjoins the respective groove 15.

As can be clearly seen, the transition region 11 between the clamping element 9 and the contact arm 8 has a smooth surface, that is, is free of contouring.

Table of Reference Numerals

| | |
|---|---|
| 1 | Brake pad |
| 2 | Brake disc |
| 3 | Pad carrier plate |
| 4 | Friction lining |
| 5 | Holder |
| 6 | Recess |
| 7 | Opening |
| 8 | Contact arm |
| 9 | Clamping element |
| 10 | Clamping arm |
| 11 | Transition region |
| 12 | Opening |
| 13 | Contact face |
| 14 | Contact face |
| 15 | Groove |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake pad wear recognition device for a brake pad having a pad carrier plate and a brake lining of a disc brake, the device comprising:
a holder operatively configured to be inserted in the pad carrier plate for holding a contact conductor;
a contact arm of the holder having a receptacle for the contact conductor;
a clamping element of the holder connected with the contact arm, the clamping element having two clamping arms elastically moveable relative to one another; and
wherein transition regions of the holder between the clamping element and the contact arms are rounded in a spreading direction of the two clamping arms.

2. The device according to claim 1, wherein a groove is provided to round each transition region between the clamping element and a respective clamping arm.

3. The device according to claim 2, wherein the groove has an arcuate contour.

4. The device according to claim 2, wherein a transition between the groove and the clamping element has a smoothly configured surface.

5. The device according to claim 3, wherein a transition between the groove and the clamping element has a smoothly configured surface.

6. The device according to claim 2, wherein the groove extends continuously in the contact arm.

7. A brake pad of a disc brake, comprising:
a pad carrier plate;
a friction lining material fastened to one side of the side carrier plate;
a wear recognition device, the wear recognition device comprising a holder arranged in the pad carrier plate for holding a contact conductor, the holder including a contact arm having a receptacle for the contact conductor and a clamping element with two clamping arms connected to the contact arm, the two clamping arms being elastically moveable relative to one another; and
wherein transition regions between the contact arm and the clamping element are rounded in a spreading direction of the two clamping arms.

8. The device according to claim 7, wherein a groove is provided to round each transition region between the clamping element and a respective clamping arm.

9. The device according to claim 8, wherein the groove has an arcuate contour.

10. The device according to claim 8, wherein a transition between the groove and the clamping element has a smoothly configured surface.

11. The device according to claim 8, wherein the groove extends continuously in the contact arm.
